(19) United States
(12) Patent Application Publication
(10) Pub. No.: US 2007/0139363 A1
(43) Pub. Date: Jun. 21, 2007

(54) Mobile phone

(76) Inventor: Chiang-Shui Huang, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/303,978

(22) Filed: Dec. 19, 2005

(51) Int. Cl. G09G 5/00

(52) U.S. Cl. 345/156

(57) ABSTRACT

The present invention provides a mobile phone including a-mobile phone body, a cursor sensor, briefing buttons and briefing cursor interface circuitry. The mobile phone body has a communication microprocessor and a keypad. The cursor sensor disposed on the surface of the mobile phone body, senses and outputs briefing cursor controlling signals in response to manual touch and movement on the cursor sensor. The briefing buttons disposed on the surface of the mobile phone body generates briefing button controlling signals in response to manual press on the briefing buttons. The briefing cursor interface circuitry connects with the communication microprocessor, the cursor sensor, and the briefing buttons, and a host computer. The communication microprocessor controls the briefing cursor interface circuitry to be switched on and off so as to control the transmission of the briefing cursor controlling signals and the briefing button controlling signals to the host computer.

### BACKGROUND OF THE INVENTION

1. Field of the Invention

The present invention relates to a mobile phone, and more particularly to a mobile phone capable of controlling briefing.

2. The Related Art

Traditionally, notebook computer projects a briefing in cooperation with a liquid crystal projector. The briefing picture cursor is controlled by a mouse or a portable briefing apparatus. In this way, to give a briefing, a user must carry an extra mouse or a briefing apparatus besides a large notebook computer and a liquid crystal projector, which is very inconvenient for the briefing user.

Looking back into the late few years, the mobile phone has become users' paraphernalia to convenient communication. In addition, for communication function, the mobile phone also provides some extra functions that would seem fantastic a decade ago, such as Infrared Ray (IR) data transmission, Global Positioning System (GPS) for security purpose, Internet linkage, etc. It would be possible and popular to combine the mobile phone with a function of controlling briefing.

### SUMMARY OF THE INVENTION

An object of the present invention is to provide a mobile phone capable of controlling briefing.

To fulfill the above objects, the mobile phone comprises a mobile phone body, a cursor sensor, a plurality of briefing buttons and a briefing cursor interface circuitry. The mobile phone body has a communication microprocessor and a keypad. The communication microprocessor controls and processes communication signals. The keypad generates input signals in response to manual entry on the keypad. The cursor sensor disposed on the surface of the mobile phone body senses and outputs briefing cursor controlling signals corresponding to the movement of the briefing cursor in response to manual touch and movement on the cursor sensor. The briefing buttons disposed on the surface of the mobile phone body generates briefing button controlling signals in response to manual press on the briefing buttons. The briefing cursor interface circuitry connects with the communication microprocessor, the cursor sensor, and the briefing buttons, and is adapted to connect a host computer. The briefing cursor interface circuitry switches on and off the cursor sensor and the briefing buttons, and receives the briefing cursor controlling signals from the cursor sensor and the briefing button controlling signals from the briefing buttons. The communication microprocessor controls the briefing cursor interface circuitry to be switched on and off so as to control the transmission of the briefing cursor controlling signals from the cursor sensor and the briefing button controlling signals from the briefing buttons to the host computer.

As mentioned above, the cursor sensor and the briefing buttons respectively output the briefing cursor controlling signals and the briefing button controlling signals to the host computer through the briefing cursor interface circuitry. Thus the mobile phone can control the briefing cursor. Therefore the briefing users need not to carry an extra mouse or briefing apparatus any more, which is convenient for the briefing user.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a first embodiment of a mobile phone according to the present invention;

FIG. 2 is a block diagram of the first embodiment of the mobile phone as shown in FIG. 1;

FIG. 3 is a block diagram of the first embodiment of the mobile phone showing a briefing cursor interface circuitry thereof in more detail;

FIG. 4 illustrates how the mobile phone is used to briefing;

FIG. 5 is a block diagram of a second embodiment of the mobile phone according to the present invention;

FIG. 6 is a perspective view of a third embodiment of the mobile phone according to the present invention;

FIG. 7 is a block diagram of the third embodiment of the mobile phone as shown in FIG. 6;

FIG. 8 is a perspective view of a fourth embodiment of the mobile phone according to the present invention;

FIG. 9 is a block diagram of the fourth embodiment of the mobile phone; and

FIG. 10 illustrates the fourth embodiment of the mobile phone in an open state.

### DETAILED DESCRIPTION OF THE PREFERRED EMBODIMENT

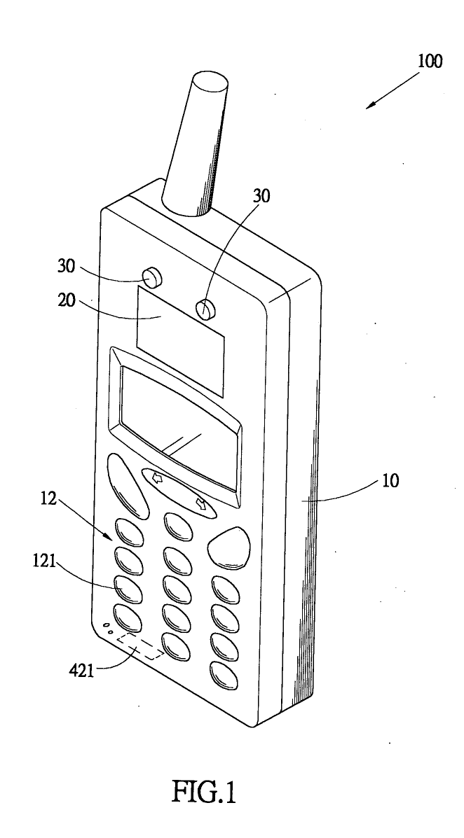

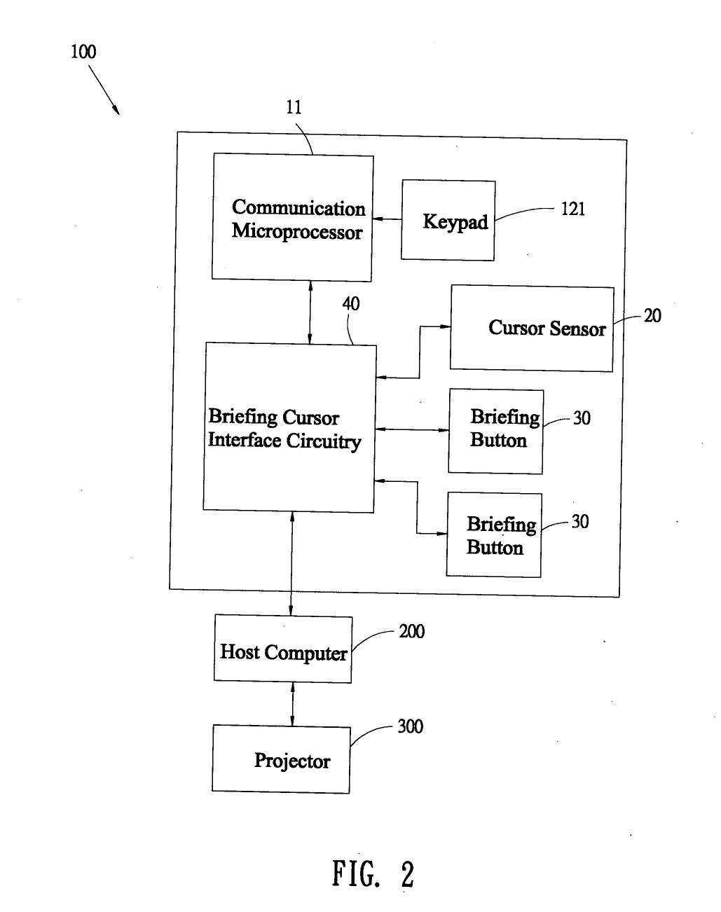

Referring now to FIG. 1 and FIG. 2, in the first embodiment of the present invention, the mobile phone 100 comprises a mobile phone body 10, a cursor sensor 20, a plurality of briefing buttons 30 and a briefing cursor interface circuitry 40. The mobile phone 10 has a communication microprocessor 11 and a keypad 12. The communication microprocessor 11 controls and processes telephone signals. The keypad 12 generates input signals in response to manual entry on the keypad 12. The keypad 12 has a press key 121 used as a mode switch for alternatively switching the briefing mode on and off.

The cursor sensor 20 is disposed on the surface of the mobile phone body 10. In the first embodiment as shown in FIG. 1 and FIG. 2, the cursor sensor 20 is a touch panel. The cursor sensor 20 senses and outputs briefing cursor controlling signals corresponding to the movement of the briefing cursor in response to manual touch and movement on the cursor sensor 20.

The briefing buttons 30 disposed on the surface of the mobile phone body 10, generates briefing button controlling signals in response to manual press on the briefing buttons 30.

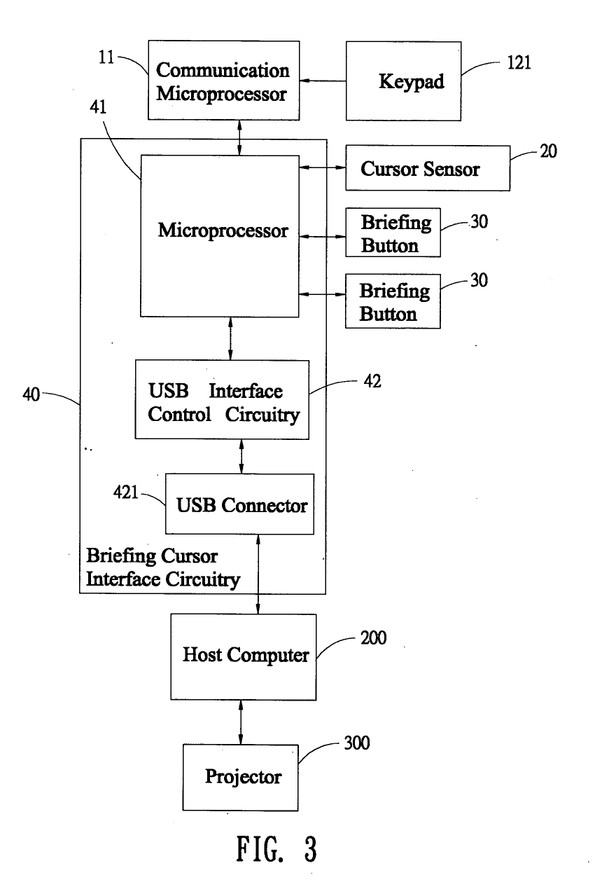

Referring now to FIG. 3, the briefing cursor interface circuitry 40 is disposed inside the mobile phone body 10. In the first embodiment of the present invention, the briefing cursor interface circuit 40 is USB mouse interface. Other types of equivalent transmission interface for briefing cursor signals, such as PS/2, RS-232, will be appreciated, alternatively. The briefing cursor interface circuit 40 comprises a microprocessor 41 and a USB interface control circuitry 42. The microprocessor 41 connects with the communication microprocessor 11 which switches on and off the briefing cursor interface circuit 40 according to the press state of the press key 121. For example, when the press key 121 is pressed for a first time, the communication processor 11 activates the briefing cursor interface circuitry 40, so the mobile phone 100 is operated in the briefing mode. Thereafter, when the key is pressed again, the briefing cursor interface circuitry 40 is inactivated, and the briefing mode of the mobile phone 100 is off, while the communication mode is on.

The cursor sensor 20 and the briefing buttons 30 connect with the microprocessor 41. The microprocessor 41 receives and processes the briefing cursor controlling signals from the cursor sensor 20 and the briefing button controlling signals from the briefing buttons 30. The microprocessor 41 outputs the briefing cursor controlling signals and the briefing button controlling signals to a host computer 200 through the USB interface control circuitry 42.

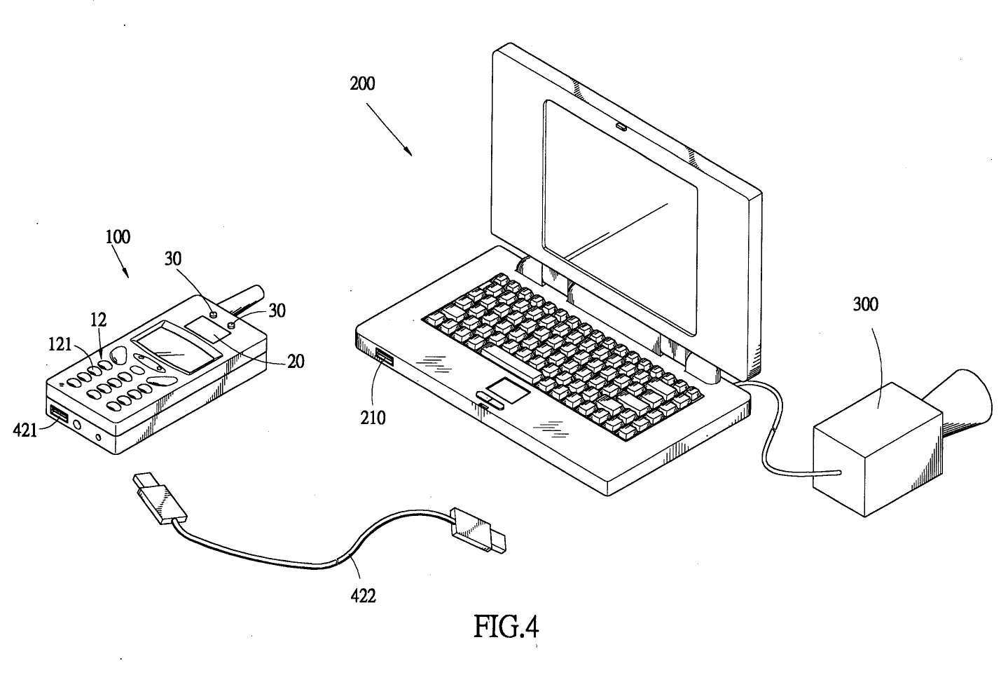

As shown in FIG. 4, the USB interface control circuitry 42 connecting with the microprocessor 41 receives the briefing cursor controlling signals and the briefing button cursor controlling signals from the microprocessor 41 and then converts the briefing cursor controlling signals and the briefing button cursor controlling signals to accord with USB standard. The USB interface control circuitry 42 connects with a USB connector 421 disposed on the peripheral side of the mobile phone body 10. The USB connector 421 connects with a USB connecting port 210 provided at the host computer 200 through a USB cable 422. Then the briefing cursor interface circuitry 40 transmits the briefing cursor controlling signals and the briefing button cursor controlling signals to the host computer 200 to control the briefing cursor. The host computer 200 transmits the briefing picture to a projector 300. According to the present invention, the host computer 200 may be a desktop computer, a notebook or a tablet computer, etc.

As shown in FIG. 4, when the mobile phone 100 is connected to the host computer 200, the press key 121 of the keypad 12 is pressed to activate the briefing mode of the mobile phone 100, and the briefing cursor interface circuitry 40 transmits the briefing cursor controlling signals and the briefing button controlling signals to the host computer 200, so the mobile phone 100 is operated as a common briefing apparatus to control the briefing cursor. When the mobile phone 100 has a telephone in, the press key 121 is pressed again to switch the briefing mode to the communication mode, during which the briefing mode and the briefing cursor in the host computer 200 is halted at final position. That is to say, the briefing projected by the projector 300 is halted at final position. When the communication is over, the press key 121 is pressed again to switch the briefing mode on.

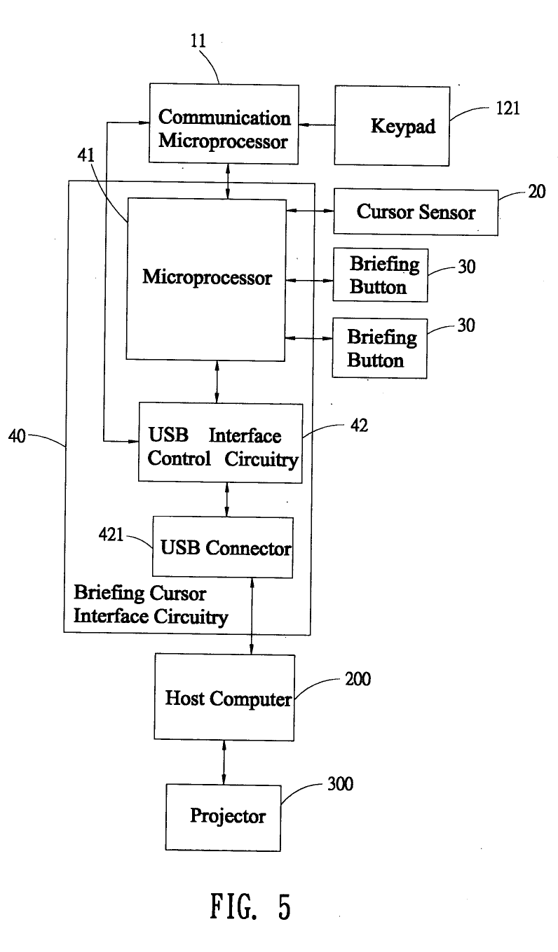

FIG. 5 shows a second preferred embodiment of the mobile phone 100 according to the present invention. The USB interface control circuitry 42 connects with the communication microprocessor 11 to enable the communication microprocessor 11 to connect to the host computer 200 or a memory card reader or a digital camera or a MP3 player or other multimedia device through the USB interface control circuitry 42 and USB connector 421 when the press key 121 is pressed to switch the briefing mode off. Thus the mobile phone 100 provides image data, audio data, newsletter, or address book data transmission interface for data uploading/downloading. When the press key 121 is pressed again, the briefing mode is activated again; meanwhile the data transmission interface of the communication microprocessor 11 is automatically shut off.

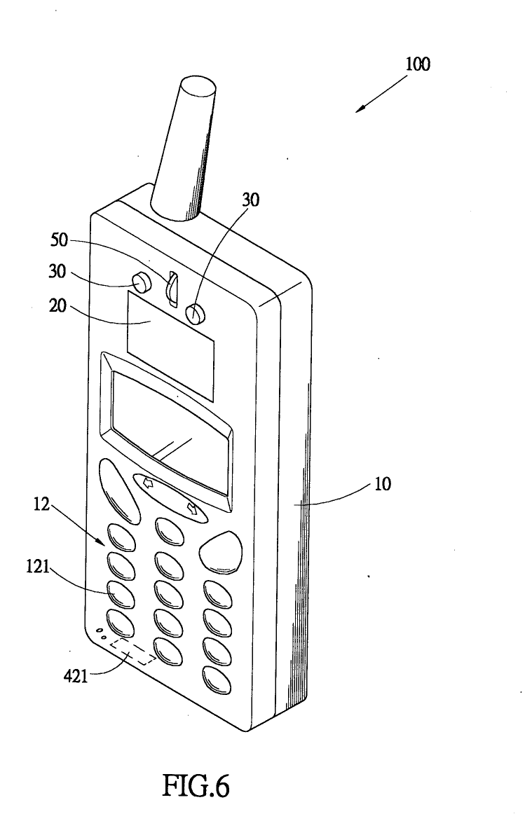

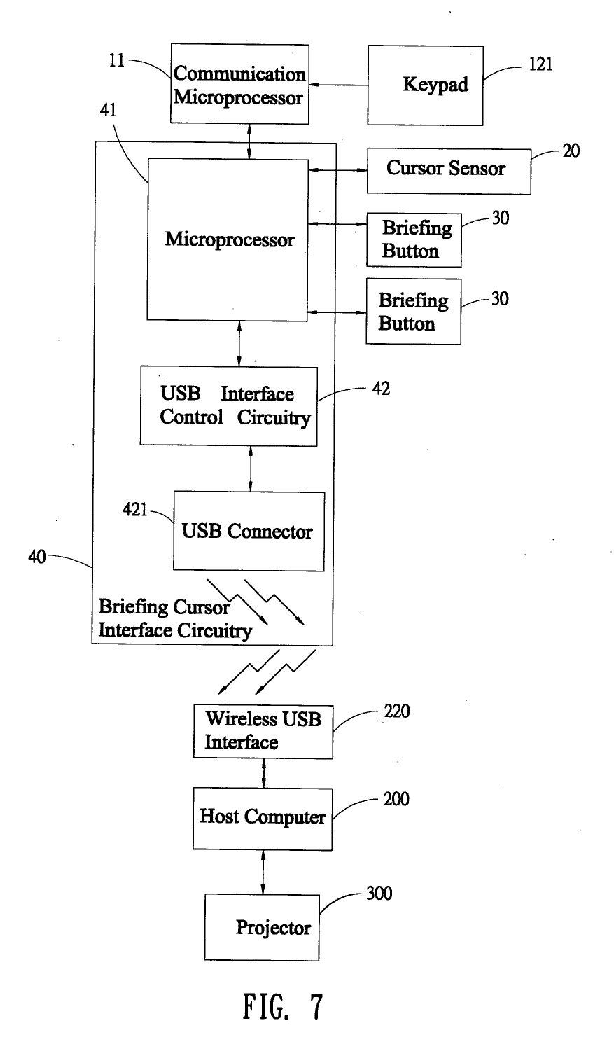

A third embodiment of the mobile phone 100 in according with the present invention is shown in FIG. 6 and FIG. 7. The mobile phone 100 further comprises a scroll wheel 50 disposed on the peripheral side of the mobile phone body 10. According to this preferred embodiment, the scroll wheel 50 is disposed on the front surface of the mobile phone body 10. The scroll wheel 50 connects with the microprocessor 41, so the scroll wheel 50 provides briefing scroll wheel controlling signals to the microprocessor 40 similar to a mouse scroll wheel. The briefing scroll wheel controlling signals are transmitted to the host computer 200 through the USB connector 421 of the USB interface control circuitry 42, thus the mobile phone 100 performs the scroll wheel controlling function control the scrolling of the briefing picture.

Referring to FIG. 7, the USB interface control circuitry 42 is a wireless USB transmission interface, and correspondingly, the host computer 200 has a wireless USB interface 220. So the briefing cursor controlling signals, the briefing button controlling signals and the briefing scroll wheel controlling signals is transmitted to the host computer 200 through wireless transmission manner.

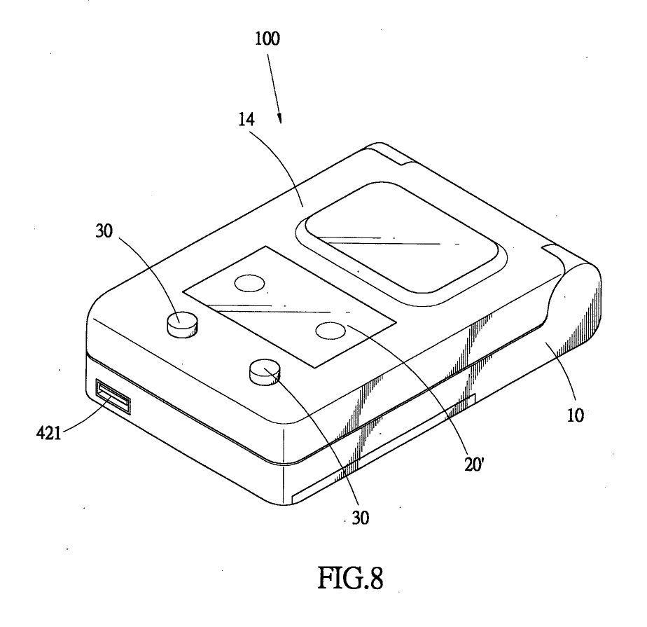

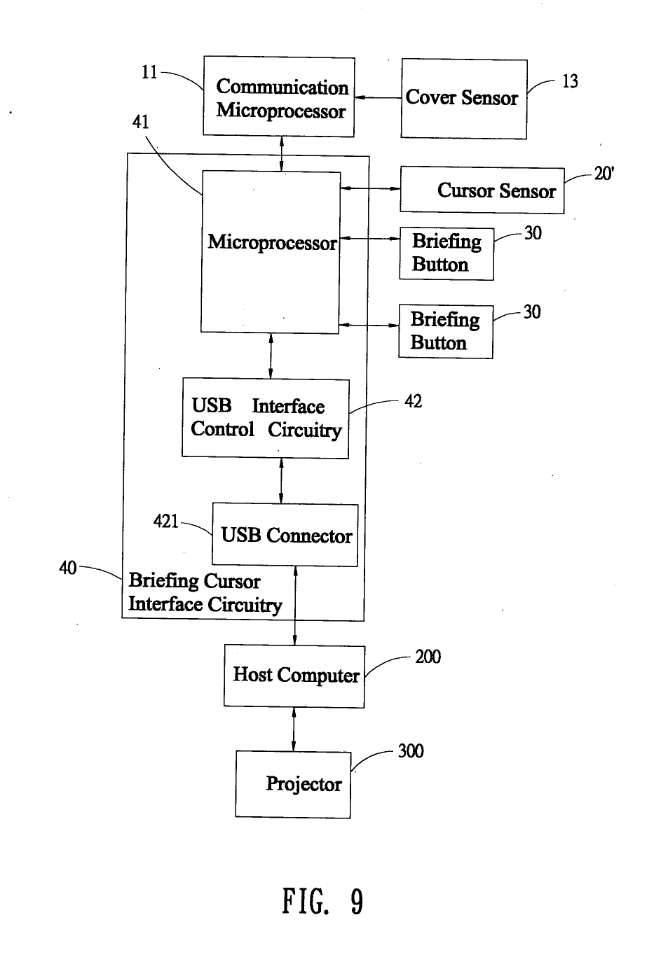

Referring to FIGS. 8, 9 and 10, a fourth embodiment of the present invention is shown. The mobile phone body 10 is a flip-style phone (as shown in FIG. 8). A cover sensor 13 is disposed on the mobile phone body 10 for sensing whether the upper cover 14 of the mobile phone body 10 is in open state or close state. The cursor sensor 20′ and the briefing button 30 is disposed on the surface of the upper cover 14 (as shown in FIG. 8). The cursor sensor 20′ is an optical sensor.

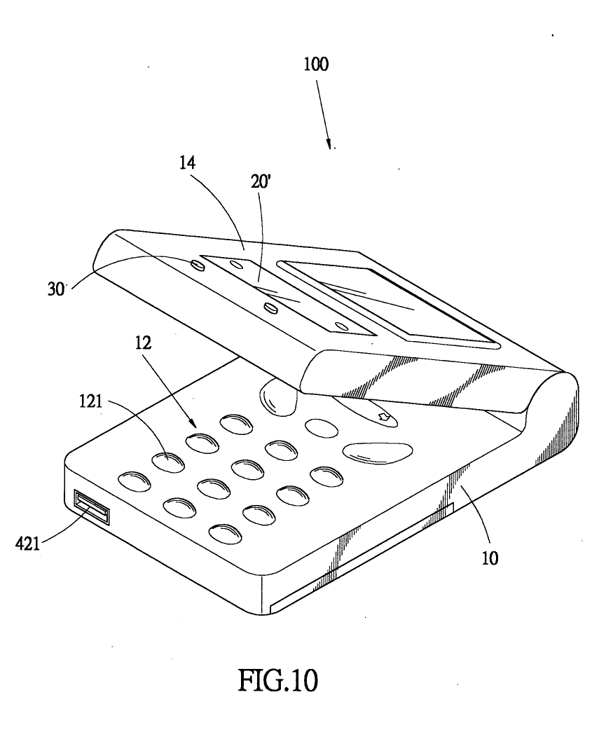

The cover sensor 13 connects to a control pin (not shown) of the communication microprocessor 11. The open or close signals from the cover sensor are transmitted to the control pin of the communication microprocessor 11, and then the communication microprocessor 11 controls whether to transmit briefing cursor controlling signals and briefing button controlling signals to the host computer 200. That is to say, while the briefing cursor interface circuitry 40 is controlling the briefing cursor, once the upper cover 14 is opened (as shown in FIG. 10), the cover sensor senses and outputs an open signal to the communication microprocessor 11 to make the communication microprocessor 11 simultaneously shut off the transmission of the briefing cursor controlling signals and the briefing button controlling signals from the briefing cursor interface circuitry 40 to the host computer 200. Meanwhile, the briefing cursor is halted at the last position. Until the upper cover 14 of the mobile phone body 10 is closed, the briefing mode is activated again.

While the present invention has been described with reference to some specific embodiment thereof, the description is illustrative and is not to be construed as limiting the invention. Various modifications to the present invention may be made to the preferred embodiment by those skilled in the art without departing from the true spirit and scope of the invention as defined by the appended claims.

What is claimed is:

1. A mobile phone, comprising:
a mobile phone body having a communication microprocessor and a keypad, the communication microprocessor controlling and processing communication signals, the keypad generating input signals in response to manual entry on the keypad;
a cursor sensor disposed on the surface of the mobile phone body, the cursor sensor sensing and outputting briefing cursor controlling signals corresponding to the movement of the briefing cursor in response to manual touch and movement on the cursor sensor;
a plurality of briefing buttons disposed on the surface of the mobile phone body, the briefing buttons generating briefing button controlling signals in response to manual press on the briefing buttons; and
a briefing cursor interface circuitry connecting with the communication microprocessor, the cursor sensor, and the briefing buttons, and the briefing cursor interface circuitry being adapted to connect a host computer, the briefing cursor interface circuitry switching on and off the cursor sensor and the briefing buttons, and receiving the briefing cursor controlling signals from the cursor sensor and the briefing button controlling signals from the briefing buttons, the communication microprocessor switching the briefing cursor interface circuitry on and off so as to control the transmission of the briefing cursor controlling signals from the cursor sensor and the briefing button controlling signals from the briefing buttons to the host computer.

2. The mobile phone as claimed in claim 1, wherein the mobile phone body has a cover sensor connected to a control pin of the communication microprocessor to control the briefing cursor interface circuitry to be switched on and off.

3. The mobile phone as claimed in claim 1, wherein a scroll wheel is disposed on the mobile phone body.

4. The mobile phone as claimed in claim 1, wherein the cursor sensor is a touch panel.

5. The mobile phone as claimed in claim 1, wherein the cursor sensor is optical sensor.

6. The mobile phone as claimed in claim 1, wherein the briefing cursor interface circuitry comprises a microprocessor connecting with the communication microprocessor and a USB interface control circuitry connecting with the microprocessor and the host computer.

7. The mobile phone as claimed in claim 6, wherein further comprises a USB connector connecting the USB interface control circuitry and the host computer.

8. The mobile phone as claimed in claim 6, wherein the USB interface control circuitry is wireless USB interface.

9. The mobile phone as claimed in claim 1, wherein the briefing cursor interface circuitry comprises a microprocessor connecting with the communication microprocessor and a USB interface control circuitry connecting with the microprocessor, the communication microprocessor and the host computer.

10. The mobile phone as claimed in claim 9, wherein further comprises a USB connector connecting the USB interface control circuitry and the host computer.

11. The mobile phone as claimed in claim 9, wherein the USB interface control circuitry is wireless USB interface.

12. The mobile phone as claimed in claim 1, wherein the keypad has a press key controlling the briefing cursor interface circuitry to be switched on and off.
